(19) United States
(12) Patent Application Publication
(10) Pub. No.: US 2025/0148705 A1
(43) Pub. Date: May 8, 2025

(54) LOCKING AND SHOWING MOVING OBJECTS IN VIRTUAL REALITY

(71) Applicant: INTERNATIONAL BUSINESS MACHINES CORPORATION, ARMONK, NY (US)

(72) Inventors: Raymund Lin, Taipei City (TW); Nan Chen, Beijing (CN); Li Na Wang, Beijing (CN); Ye Chuan Wang, Beijing (CN); Ju Ling Liu, Beijing (CN)

(21) Appl. No.: 18/501,066

(22) Filed: Nov. 3, 2023

(51) Int. Cl. G06T 17/00; G06T 5/50; G06T 7/11; G06T 7/20; G06V 10/764

(52) U.S. Cl. CPC G06T 17/00; G06T 5/50; G06T 7/11; G06T 7/20; G06V 10/764; G06T 2207/20221; G06T 2207/30241; G06V 2201/07

(57) ABSTRACT

According to one embodiment, a method, computer system, and computer program product for physical object tracking in virtual reality is provided. The present invention may include receiving input from a user identifying a specific physical object during a virtual reality session in a virtual reality environment; identifying the specific physical object in the physical proximity of the user; tracking the location of the specific physical object relative to the user; and responsive to receiving a command from the user, displaying the specific physical object to the user through a portal in the virtual reality environment.

### BACKGROUND

The present invention relates, generally, to the field of computing, and more particularly to virtual reality.

The field of virtual reality (VR) is concerned with creating three-dimensional, interactive virtual environments that are geographically anchored to and otherwise integrate elements of the real world, such that a human user's physical movements and actions may be tracked and mapped to movements and actions of a virtual representation of the user within the virtual environment. A VR system may achieve this immersion in the virtual environment using specialized hardware such as virtual reality headsets, motion controllers, and tracking systems that allow a user to respectively look around, pick up and manipulate virtual objects, and move within the virtual environment. VR applications can vary widely, from entertainment and gaming to educational, training, therapeutic, and even scientific purposes.

### SUMMARY

According to one embodiment, a method, computer system, and computer program product for physical object tracking in virtual reality is provided. The present invention may include receiving input from a user identifying a specific physical object during a virtual reality session in a virtual reality environment; identifying the specific physical object in the physical proximity of the user; tracking the location of the specific physical object relative to the user; and responsive to receiving a command from the user, displaying the specific physical object to the user through a portal in the virtual reality environment.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a VR object tracking process according to at least one embodiment;

FIG. 3 is a diagram illustrating an exemplary use case of the VR object tracking process according to at least one embodiment;

FIG. 4 is a diagram illustrating an exemplary use case of the VR object tracking process according to at least one embodiment; and

FIG. 5 is a diagram illustrating an exemplary use case of the VR object tracking process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to virtual reality. The following described exemplary embodiments provide a system, method, and program product to, among other things, dynamically track locations of one or more physical objects in the physical environment of a user experiencing a virtual reality environment, and allow the user to view selected physical objects through the virtual environment.

As previously described, the field of virtual reality (VR) is concerned with creating three-dimensional, interactive virtual environments that are geographically anchored to and otherwise integrate elements of the real world. These virtual environments may be overlaid over the physical world to the perception of a user, such that even though the virtual environment is anchored to the physical world and the user's movement within the physical world is replicated within the virtual environment, the user nevertheless cannot see physical objects or environmental elements while immersed within the virtual environment. This presents a challenge in situations where, for example, a user wishes to interact with one or more select real world objects, such as a cup of coffee that the user is in the process of drinking, or a mobile device on which the user is expecting a text; ordinarily, the user must take off the virtual reality headset or otherwise exit the virtual environment in order to see objects in the physical environment, which may be difficult and inconvenient. Some systems have attempted to address the problem by making a “portal” in the virtual environment centered on the physical object in question, allowing the user to see through the hole to the physical object; in other words, a virtual reality system may create portal, or a region in the virtual environment where the virtual environment is not displayed, such that the physical world may be perceived by the user through the portal. However, the portal is typically fixed in its position, or tied to a single location where the physical object was originally identified. If the physical object moves, or the user moves relative to the physical object, the portal may no longer be located and oriented to allow a user to view the physical object.

As such, it may be advantageous to, among other things, implement a system that intelligently tracks the location of one or more specified physical objects during a virtual reality session, creates a portal in the virtual environment that allows a user to see the specified physical objects, and dynamically moves and orients a portal to allow the user to see the one or more specified physical objects during the virtual reality session. Therefore, the present embodiment has the capacity to improve the technical field of virtual reality by enabling a virtual reality system to accurately track a physical object and allow a user visual access to that physical object accounting for movement of the user and the object, obviating the need to remove equipment and improving immersion in the virtual environment, ease of use, and the user experience.

According to at least one embodiment, the invention is a method and system for receiving specified physical objects from a user, identifying the specified physical objects in the physical environment of the user from among other similar objects, tracking the location of the specified objects during a virtual reality session, and creating a portal in the virtual environment of the virtual reality session to allow the user to see the specified objects.

According to at least one embodiment, the invention is a virtual reality (VR) system comprising specialized hardware including VR display devices, motion controllers, and/or tracking systems. VR display devices may be display devices positioned within the user's field of view which graphically render the virtual environment, allowing the user to see the virtual environment through the VR display based on the position and orientation of the VR display, as if the VR display was a window into the virtual environment. VR displays may comprise head-mounted displays (HMDs), which are headsets worn on the user's head and covering the user's eyes, providing the user a stereoscopic view of the virtual world while occluding the physical world from view. HMDs often incorporate screens, lenses, and motion-tracking sensors to track the user's head movements, allowing the user to look around and explore the virtual environment. The VR system may comprise motion controllers, which track the motion of the user's limbs and may include handheld or leg-mounted wearable devices that allow users to interact with objects and elements within the virtual world. Motion controllers can be used to pick up and/or manipulate virtual objects, perform actions, and navigate through the environment. The VR system may comprise tracking systems, which may include technologies for tracking the position and movements of the user in physical space, enabling the user's corresponding movements to be accurately represented in the virtual environment. In embodiments, these tracking systems may be integrated into headsets and/or motion controllers, and/or may be separate standalone devices, such as infrared beacons deployed within the physical environment of a user during a virtual reality session, which provide data regarding the position and movement of the user during the virtual reality session.

According to at least one embodiment, the virtual reality (VR) session may be a discrete period of time where the user is interacting with a particular virtual reality program or experience through a VR system. The VR program may be a software program such as a training simulator, a game, a narrative experience such as a movie, a social platform, et cetera run and executed on a computing device that creates or provides one or more VR experiences for the user to interact with through a VR system. The VR experiences may be discrete episodes comprising one or more scenes, virtual objects, narrative elements, graphical elements, simulated characters, et cetera; the VR experiences may include training simulations, virtual tours, story vignettes, chapters of a game, et cetera. In embodiments, the VR session may begin when a VR program is initialized and may end when the VR program is terminated.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to dynamically track locations of one or more physical objects in the physical environment of a user experiencing a virtual reality environment, and allow the user to view selected physical objects through the virtual environment.

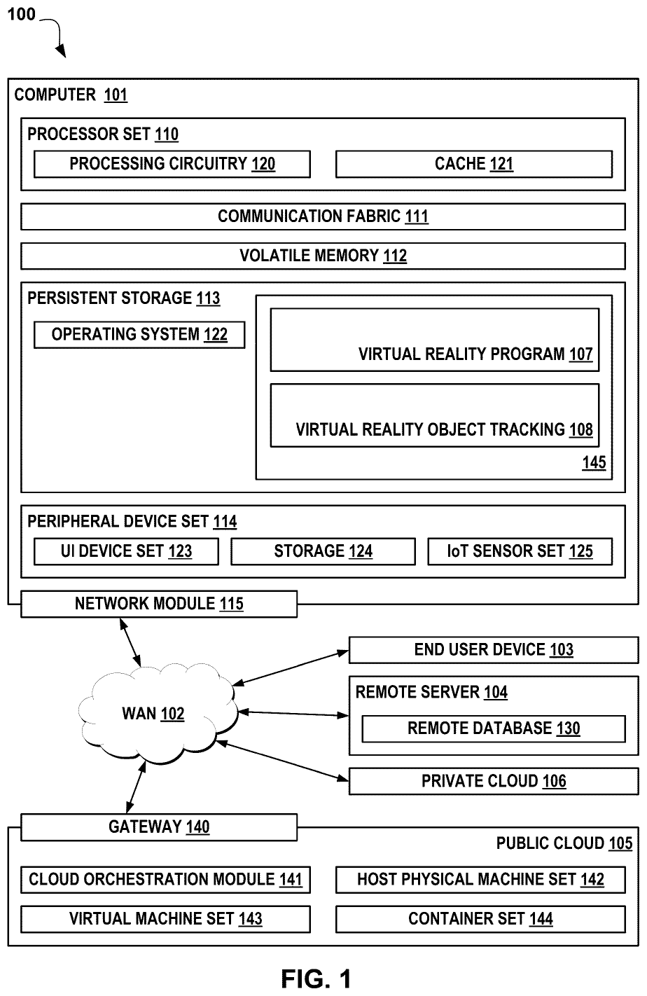

Referring now to FIG. 1, computing environment 100 contains an example of an environment for the execution of at least some of the computer code involved in performing the inventive methods, such as code block 145, which may comprise virtual reality (VR) program 107 and VR object tracking program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the virtual reality (VR) program 107 may be a software program capable of creating a VR environment that a user may experience through a VR system. The VR program 107 may be a software program such as a training simulator, a game, a narrative experience such as a movie, a social platform, et cetera run and executed on a computing device that creates or provides one or more VR experiences for the user to interact with through a VR system. The VR experiences may be discrete episodes comprising one or more scenes, virtual objects, narrative elements, graphical elements, simulated characters, et cetera; the VR experiences may include training simulations, virtual tours, story vignettes, chapters of a game, et cetera. In embodiments of the invention, the VR program 107 may be stored and/or run within or by any number or combination of devices including computer 101, end user device 103, remote server 104, private cloud 106, and/or public cloud 105, peripheral device set 114, and server 112 and/or on any other device connected to WAN 102. Furthermore, VR program 107 may be distributed in its operation over any number or combination of the aforementioned devices.

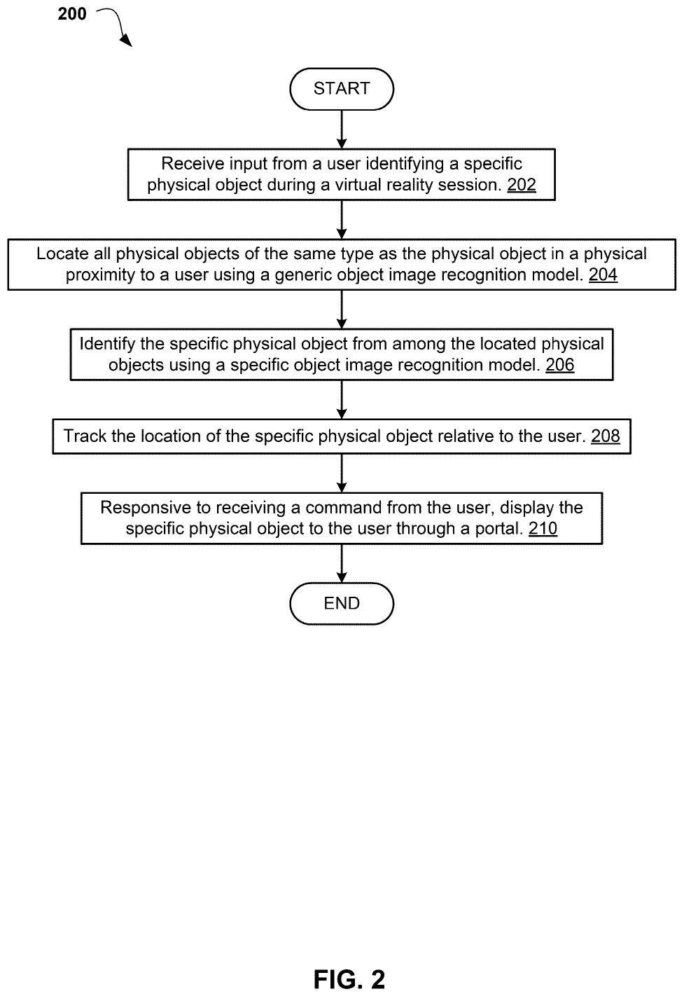

According to the present embodiment, the VR object tracking program 108 may be a software program enabled to dynamically track locations of one or more physical objects in the physical environment of a user experiencing a virtual reality environment, and allow the user to view selected physical objects through the virtual environment. The VR object tracking program 108 may, when executed, cause the computing environment 100 to carry out an VR object tracking process 200. The VR object tracking process 200 may be explained in further detail below with respect to FIG. 2. In embodiments of the invention, the VR object tracking program 108 may be stored and/or run within or by any number or combination of devices including computer 101, end user device 103, remote server 104, private cloud 106, and/or public cloud 105, peripheral device set 114, and server 112 and/or on any other device connected to WAN 102. Furthermore, VR object tracking program 108 may be distributed in its operation over any number or combination of the aforementioned devices. In embodiments, the VR object tracking program 108 may be a functionality, subroutine, subcomponent, et cetera of VR program 107, and/or may otherwise be designed to interoperate and/or communicate with VR program 107.

Referring now to FIG. 2, an operational flowchart illustrating a VR object tracking process 200 is depicted according to at least one embodiment. At 202, the VR object tracking program 108 may receive input from a user identifying a specific physical object during a virtual reality session. This input may be an audible spoken command or query, an interaction with a UI or virtual reality object or element such as selection of an object from a menu, a hotkey, or any other input communicated by the user to the VR object tracking process 200. The input may be received during a virtual reality session, for example while the user is immersed in a virtual reality experience and/or is wearing a virtual reality headset. The input may indicate a specific physical object. The specific physical object may be any specific physical object that a user wishes the VR object tracking process 200 to track, and to display to the user responsive to the user's command at any given moment. For example, the specific physical object may be a particular coffee mug filled with coffee, that the user is drinking from or intends to drink, or a mobile phone that the user wants to check for messages.

At 204, the VR object tracking program 108 may locate all physical objects of the same type as the physical object in a physical proximity to the user using a generic object image recognition model. Here, the VR object tracking program 108 may utilize one or more cameras, for example those integrated into a virtual reality headset or mobile device on the person of the user, or those deployed in the environment of the user, for example as part of a virtual reality system, to identify at least one object around the user matching the type of the specific physical object. The VR object tracking program 108 may utilize a generic object image recognition model, which may be a machine learning model that has been trained using large datasets to identify instances of a generic type of object, such as cups, mobile phones, pencils, et cetera, even as it may not be able to distinguish between individual members of that type.

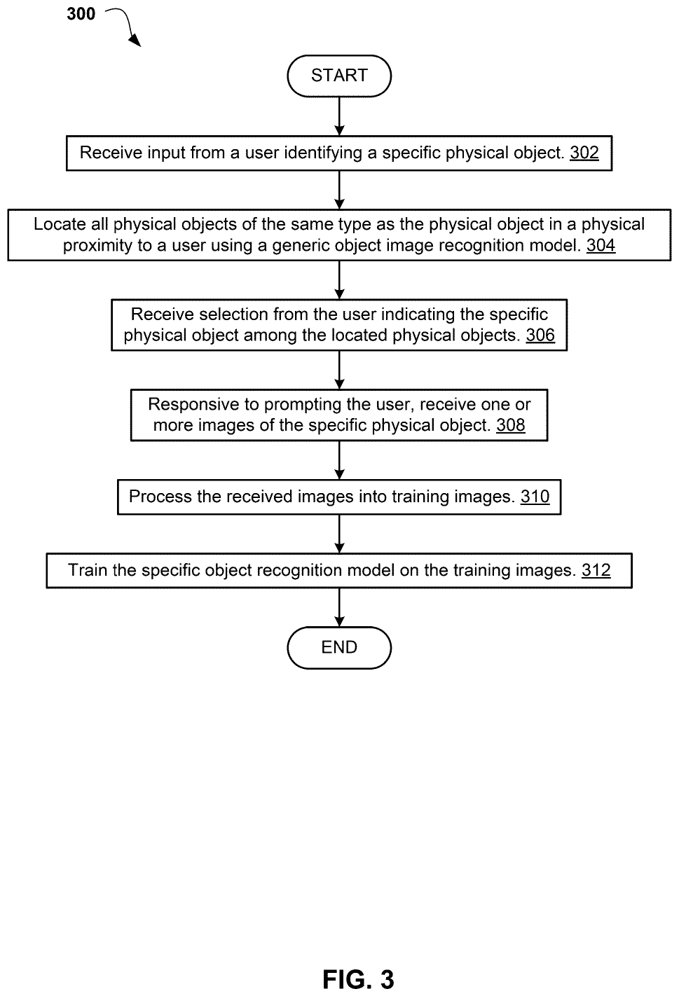

At 206, the VR object tracking program 108 may identify the specific physical object from among the located physical objects using a specific object image recognition model. The specific object image recognition model may be a machine learning model which, given images of items of the same type as the specific physical object as identified by the generic object image recognition model, may identify the specific physical objects from among the located objects of the same type. The training of the specific object image recognition model may be discussed in greater detail below with respect to FIG. 3.

At 208, the VR object tracking program 108 may track the location of the specific physical object relative to the user. Once the specific physical object has been identified, the VR object tracking program 108 may track the location of the specific physical object. While the specific physical object is within the visual field of the cameras available to the VR object tracking program 108, such as the cameras integrated into the virtual reality headset, the VR object tracking program 108 may analyze the camera feed at regular intervals to identify the specific physical object within the camera feed, and to thereby track the location of the specific physical object. In embodiments, for example should VR object tracking program 108 determine that the specific physical object has left the visual field of the cameras, and the specific physical object has moved, the VR object tracking program 108 may identify a three-dimensional zone of possible locations that the specific physical object may have moved to. For example, the VR object tracking program 108 may utilize a moving path prediction algorithm to select the most likely location of the specified physical object based on, for example, a location history of the specific physical object, and may predict possible next locations for the specified physical object.

In embodiments, once initialized, VR object tracking program 108 may store the identified specific physical object in non-volatile memory, and may resume tracking even where the VR device, mobile device, computer 110, et cetera has been shut off, once the power has been restored. The tracking may be terminated if the VR object tracking program 108 receives a user request that the tracking be shut off or receives a different specific physical object to track from the user. In this way, VR object tracking program 108 may persistently track the specific physical object across multiple virtual reality sessions.

At 210, the VR object tracking program 108 may, responsive to receiving a command from a user, display the specified physical object to the user through a portal. Upon receiving a user command to display the specified physical object, which may include a verbal command received at a microphone integrated into a virtual reality headset or other device controlled or in communication with VR object tracking program 108, a command issued by interfacing with a UI element or virtual reality element, a gesture, et cetera, the VR object tracking program 108 may open a portal in the virtual reality environment to display the specified physical object. The portal may be flat broad plane, describing, for example, a circle, oval, rectangle, or any other shape suspended in the virtual reality environment, disposed in the space between the user and the specified physical element. The portal may be oriented perpendicular to the line between the user and the specified physical element, and on the face of the portal oriented towards the user, the VR object tracking program 108 may display real-time camera footage of the physical world visible beyond the portal's physical location, such that the portal appears to be a window into reality that the user is looking through. The VR object tracking program 108 may orient and position the portal based on tracking the specified physical object and may dynamically maintain the size, position and orientation of the portal relative to the user and the specified physical object, such that the portal is always in a position where the specified physical object may be visible to the user beyond the portal. For example, if the specified physical object moves closer to the user, the radius of the portal may increase, while if the specified physical object moves away from the user, the VR object tracking program 108 may decrease the radius of the portal. If

Referring now to FIG. 3, an operational flowchart illustrating a training process 300 of a specific object image recognition model is depicted according to at least one embodiment. At 302, the VR object tracking program 108 may receive input from a user identifying a specific physical object. This input may be an audible spoken command or query, an interaction with a UI or virtual reality object or element such as selection of an object from a menu, a hotkey, or any other input communicated by the user to the VR object tracking process 200. The input may indicate a specific physical object. The specific physical object may be any specific physical object that a user wishes the VR object tracking process 200 to track, and to display to the user responsive to the user's command at any given moment. For example, the specific physical object may be a particular coffee mug filled with coffee, that the user is drinking from or intends to drink, or a mobile phone that the user wants to check for messages.

At 304, the VR object tracking program 108 may locate all physical objects of the same type as the physical object in a physical proximity to the user using a generic object image recognition model. Here, the VR object tracking program 108 may utilize one or more cameras, for example those integrated into a virtual reality headset or mobile device on the person of the user, or those deployed in the environment of the user, for example as part of a virtual reality system, to identify at least one object within a threshold distance around the user matching the type of the specific physical object. The VR object tracking program 108 may utilize a generic object image recognition model, which may be a machine learning model that has been trained using large datasets to identify instances of a generic type of object, such as cups, mobile phones, pencils, et cetera, even as it may not be able to distinguish between individual members of that type.

At 306, the VR object tracking program 108 may receive a selection from the user indicating the specific physical object among the located physical objects. Here, the user may indicate to the VR object tracking program 108 which of the located physical objects comprises the specific physical object, for example by gesturing towards or touching an image of a set of images displayed in virtual reality depicting the different generic objects to select one. The VR object tracking program 108 may prompt the user to make and transmit the selection of the specified physical object from among the identified generic types, for example using textual, graphical, or audible means. The selected specific physical object may be stored in a list or database, along with information comprising the specific physical object's type, past movement, name, et cetera, for future reference.

At 308, the VR object tracking program 108 may, responsive to prompting the user, receive one or more images of the specific physical object. The prompt may comprise a virtual element in a virtual reality environment and/or a virtual element on a display device, such as a mobile device, such as a textual, audible, and/or tactile message transmitted to the user. The prompt may include, for example, a text box, a picture, audible natural speech, et cetera. The VR object tracking program 108 may prompt the user to take multiple pictures of the specific physical object, for example using a mobile device and/or using the cameras integrated into a virtual reality device. The VR object tracking program 108 may prompt the user to turn the specific physical object to capture roughly all sides of the specific physical object. The VR object tracking program 108 may further prompt the user to remove the specific physical object while maintaining the same angle and positioning of the camera, and to record images of the background, such that the VR object tracking program 108 may have information on the background without the specific physical object present. The VR object tracking program 108 may prompt the user to transmit these images to the VR object tracking program 108, and/or may operate the virtual reality headset or other cameras to record the images directly.

At 310, the VR object tracking program 108 may process the received images into training images. The VR object tracking program 108 may utilize few-shot image classification to generate training images; few-shot image classification is a machine learning task that focuses on training models to recognize and classify images when only a limited amount of labeled training data is available. Here, only a few images may be taken of the specific physical object; accordingly, VR object tracking program 108 must process the received images into enough training images to form a sufficiently large dataset to enable the specific object recognition model to exceed a threshold level of accuracy. The VR object tracking program 108 may subtract the background images from the images with the specific physical object, to produce images comprising only the specific physical object. The VR object tracking program 108 may then cut the picture of the background into a number of regions; the set of images comprising regions that do not include the specific physical object may be labeled as negative samples. The VR object tracking program 108 may create a second set of training images by compositing a different image of the specific physical object onto each empty region (negative example) to generate images comprising different views of the specific physical object against different regions of the background, which may be labeled as positive samples for image-based training, along with the region that originally contained the specific physical object. The VR object tracking program 108 may consider the depth of the background in creating the positive samples, to generate realistic positive samples. The VR object tracking program 108 may iterate through this process to generate a sufficient number of training images comprising negative samples and positive samples to train the specific object recognition model. The VR object tracking program 108 may determine the number of iterations based on, for example, the power of the computer 101, remote server 104, and/or end user device 103.

At 312, the VR object tracking program 108 may train the specific object recognition model on the training images. Here, the VR object tracking program 108 may provide the training data comprising the paired images labeled positive samples and negative samples to the specific object recognition model; the model may learn to predict which images include the specific physical object and which do not. The specific object recognition model's accuracy in correctly identifying whether the specific physical object is present in a given training image may be evaluated by VR object tracking program 108; in embodiments, the training may be repeated, and/or additional training images may be generated, until the accuracy exceeds a minimum accuracy threshold.

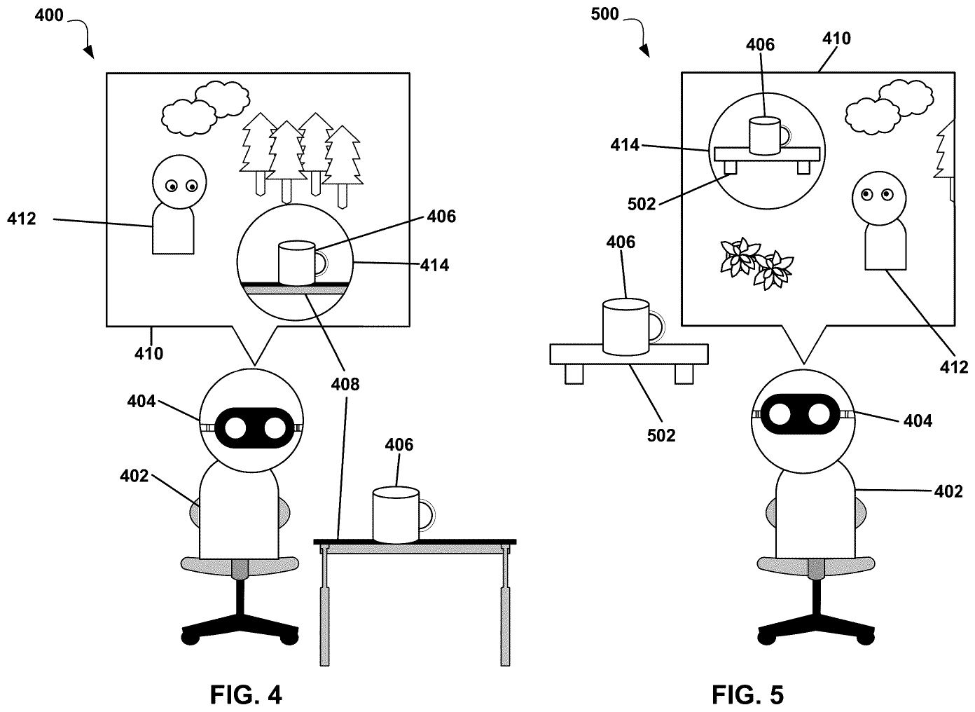

Referring now to FIG. 4, a diagram illustrating an exemplary use case 400 of the VR object tracking process 200 is depicted according to at least one embodiment. Here, a user 402 is sitting on a chair, wearing a virtual reality headset 404 and sitting before a table 408 upon which is a coffee mug 406. The user 402 is immersed in a virtual world 410, where he is represented by an avatar 412. The user 402 wishes to drink his coffee and issues a verbal command to VR object tracking program 108 to open a portal to his coffee mug, which is received through a microphone integrated into the virtual reality headset 404. The VR object tracking program 108 opens a portal 414 in the virtual reality environment 410, such that the user 402 can see the location of the coffee mug 406 on the table 408.

Referring now to FIG. 5, a diagram illustrating an exemplary use case 500 of the VR object tracking process 200 is depicted according to at least one embodiment. Here, user 402 remains immersed in virtual reality simulation 410. However, upon drinking the coffee from coffee mug 406, user 402 placed it on shelf 502. The VR object tracking program 108 tracks and identifies the movement of the coffee mug 406 at many intervals throughout the day, so as to keep track of the coffee mug's location and record its passage from table 408 to shelf 502. When the user requests to see the coffee mug so that he might drink, the VR object tracking program 108 displays the coffee mug by opening a portal 414 in the virtual world 410, through which the coffee mug 406 and shelf 502 may be seen.

It may be appreciated that FIGS. 2-5 provide only illustrations of individual implementations and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for physical object tracking in virtual reality, the method comprising:
receiving input from a user identifying a specific physical object during a virtual reality session in a virtual reality environment;
identifying the specific physical object in a physical proximity of the user;
tracking the location of the specific physical object relative to the user; and
responsive to receiving a command from the user, displaying the specific physical object to the user through a portal in the virtual reality environment.

2. The method of claim 1, wherein the identifying further comprises:
identifying one or more physical objects of a same type as the specific physical object in the physical proximity to the user using a generic object recognition model; and
identifying the specific physical object from among the located physical objects using a specific object recognition model.

3. The method of claim 2, wherein the specific object recognition model is trained using a few-shot image classification process.

4. The method of claim 2, wherein the specific object recognition model is trained using a method comprising:
responsive to prompting the user to record a plurality of images of the specific physical object and a background, receiving the plurality of images;
processing the received images into training images;
training the specific object recognition model on the training images.

5. The method of claim 4, wherein the processing further comprises:
dividing the received images of the background into a plurality of regions to create a plurality of negative examples; and
compositing images of the specific physical object onto the plurality of regions to create a plurality of positive examples, wherein the training images comprise the plurality of negative examples and the plurality of positive examples.

6. The method of claim 1, wherein the tracking further comprises;
Responsive to determining that the specific physical object has moved, utilizing a moving path prediction algorithm to select the most likely location of the specified physical object based on a movement history of the specific physical object.

7. The method of claim 1, wherein the tracking is persistent across multiple virtual reality experiences.

8. A computer system for physical object tracking in virtual reality, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving input from a user identifying a specific physical object during a virtual reality session in a virtual reality environment;
identifying the specific physical object in a physical proximity of the user;
tracking a location of the specific physical object relative to the user; and
responsive to receiving a command from the user, displaying the specific physical object to the user through a portal in the virtual reality environment.

9. The computer system of claim 8, wherein the identifying further comprises:
identifying one or more physical objects of a same type as the specific physical object in the physical proximity to the user using a generic object recognition model; and
identifying the specific physical object from among the located physical objects using a specific object recognition model.

10. The computer system of claim 9, wherein the specific object recognition model is trained using a few-shot image classification process.

11. The computer system of claim 9, wherein the specific object recognition model is trained using a method comprising:
responsive to prompting the user to record a plurality of images of the specific physical object and a background, receiving the plurality of images;
processing the received images into training images;
training the specific object recognition model on the training images.

12. The computer system of claim 11, wherein the processing further comprises:
dividing the received images of the background into a plurality of regions to create a plurality of negative examples; and
compositing images of the specific physical object onto the plurality of regions to create a plurality of positive examples, wherein the training images comprise the plurality of negative examples and the plurality of positive examples.

13. The computer system of claim 8, wherein the tracking further comprises;
Responsive to determining that the specific physical object has moved, utilizing a moving path prediction algorithm to select the most likely location of the specified physical object based on a movement history of the specific physical object.

14. The computer system of claim 8, wherein the tracking is persistent across multiple virtual reality experiences.

15. A computer program product for physical object tracking in virtual reality, the computer program product comprising:
one or more computer-readable tangible storage medium and program instructions stored on at least one of the one or more tangible storage medium, the program instructions executable by a processor to cause the processor to perform a method comprising:
receiving input from a user identifying a specific physical object during a virtual reality session in a virtual reality environment;
identifying a specific physical object in a physical proximity of the user;
tracking a location of the specific physical object relative to the user; and
responsive to receiving a command from the user, displaying the specific physical object to the user through a portal in the virtual reality environment.

16. The computer program product of claim 15, wherein the identifying further comprises:
identifying one or more physical objects of a same type as the specific physical object in the physical proximity to the user using a generic object recognition model; and
identifying the specific physical object from among the located physical objects using a specific object recognition model.

17. The computer program product of claim 16, wherein the specific object recognition model is trained using a few-shot image classification process.

18. The computer program product of claim 16, wherein the specific object recognition model is trained using a method comprising:
responsive to prompting the user to record a plurality of images of the specific physical object and a background, receiving the plurality of images;
processing the received images into training images;
training the specific object recognition model on the training images.

19. The computer program product of claim 18, wherein the processing further comprises:
dividing the received images of the background into a plurality of regions to create a plurality of negative examples; and
compositing images of the specific physical object onto the plurality of regions to create a plurality of positive examples, wherein the training images comprise the plurality of negative examples and the plurality of positive examples.

20. The computer program product of claim 15, wherein the tracking further comprises;
Responsive to determining that the specific physical object has moved, utilizing a moving path prediction algorithm to select the most likely location of the specified physical object based on a movement history of the specific physical object.
